(19) United States
(12) Patent Application Publication
(10) Pub. No.: US 2014/0019897 A1
(43) Pub. Date: Jan. 16, 2014

(54) INFORMATION PROCESSING APPARATUS, INFORMATION PROCESSING METHOD, AND NON-TRANSITORY COMPUTER READABLE MEDIUM

(71) Applicant: FUJI XEROX CO., LTD., Tokyo (JP)

(72) Inventor: Masanori SATAKE, Kanagawa (JP)

(73) Assignee: FUJI XEROX CO., LTD., Tokyo (JP)

(21) Appl. No.: 13/739,833

(22) Filed: Jan. 11, 2013

(30) Foreign Application Priority Data
Jul. 11, 2012 (JP) 2012-155388

(51) Int. Cl. G06F 3/0486

(52) U.S. Cl. CPC G06F 3/0486
USPC 715/769

(57) ABSTRACT

An information processing apparatus includes an object displaying unit, an object identifying unit, and an object moving unit. The object displaying unit displays at least one object in a display area of an operation display. The operation display includes the display area where an image is displayed and outputs information about a position pointed by an operator in the display area. The object identifying unit identifies an object pointed by the operator in accordance with the output information. When the position pointed by the operator is moved on the display area in a state in which the object is identified, the object moving unit moves the identified object on the display area by a distance corresponding to a moving distance of the position pointed by the operator and a coefficient that is associated with the object and that is set in advance in at least one direction.

### CROSS-REFERENCE TO RELATED APPLICATIONS

This application is based on and claims priority under 35 USC 119 from Japanese Patent Application No. 2012-155388 filed Jul. 11, 2012.

### BACKGROUND

(i) Technical Field

The present invention relates to an information processing apparatus, an information processing method, and a non-transitory computer readable medium.

(ii) Related Art

Slate devices including tablet information terminal devices frequently adopt operating systems (OSs) optimized for finger operations on displays with touch panels. In such an OS, an operation “pinch out-pinch in”, which is recognized as “enlargement-reduction in size (of images or the likes)”, provides intuitive user-friendliness. In contrast, OSs based on operations with keyboards and/or mice may be used on touch panels. Such an OS is used to meet the need to balance utilization of software asset in related art with mobility and high durability owing to omission of mechanical parts. Operations specific to the mice (for example, display of a menu by right click, scrolling with a mouse wheel, etc.) are associated with specific finger operations (sequences) in some OSs in order not to inhibit the utilization of the software asset in the related art.

### SUMMARY

According to an aspect of the invention, there is provided an information processing apparatus including an object displaying unit, an object identifying unit, and an object moving unit. The object displaying unit displays at least one object in a display area of an operation display. The operation display includes the display area where an image is displayed and outputs information about a position pointed by an operator in the display area. The object identifying unit identifies an object pointed by the operator in accordance with the information output from the operation display. When the position pointed by the operator is moved on the display area in a state in which the object is identified by the object identifying unit, the object moving unit moves the object identified by the object identifying unit on the display area by a distance corresponding to a moving distance of the position pointed by the operator and a coefficient that is associated with the object and that is set in advance in at least one direction.

### BRIEF DESCRIPTION OF THE DRAWINGS

Exemplary embodiments of the present invention will be described in detail based on the following figures, wherein:

FIG. 1 is a block diagram illustrating an example of the configuration of an information processing apparatus according to an exemplary embodiment of the invention;

FIG. 2 illustrates an example of the content of moving distance coefficients stored in a moving distance coefficient storage area;

FIG. 3 is a block diagram illustrating an example of the functional configuration of the information processing apparatus according to the exemplary embodiment;

FIG. 4 is a flowchart illustrating a process performed by the information processing apparatus;

FIG. 5 is a diagram for describing an example of the content of an object moving process;

FIG. 6 is a diagram for describing another example of the content of the object moving process;

FIG. 7 is a diagram for describing another example of the content of the object moving process;

FIG. 8 is a diagram for describing an example of the content of an object moving process according to a modification;

FIG. 9 is a diagram for describing the example of the content of the object moving process according to the modification;

FIG. 10 is a diagram for describing the example of the content of the object moving process according to the modification;

FIG. 11 is a diagram for describing the content of an operation by a user in an apparatus in related art; and

FIG. 12 is another diagram for describing the content of an operation by the user in the apparatus in the related art.

### DETAILED DESCRIPTION

### Configuration

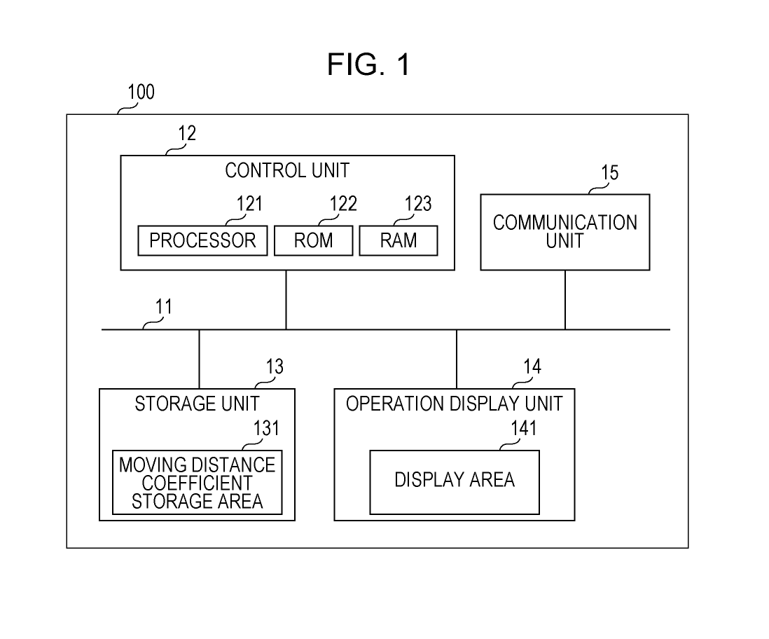

FIG. 1 is a block diagram illustrating an example of the configuration of an information processing apparatus 100 according to an exemplary embodiment of the invention. The information processing apparatus 100 is provided with a touch panel. The information processing apparatus 100 is, for example, a smartphone or a tablet computer. As illustrated in FIG. 1, each component in the information processing apparatus 100 is connected to a bus 11. Data is exchanged between the components via the bus 11. Referring to FIG. 1, a control unit 12 includes a processor 121, such as a central processing unit (CPU), a read only memory (ROM) 122, and a random access memory (RAM) 123. The control unit 12 controls the information processing apparatus 100 in accordance with computer programs stored in the ROM 122 or a storage unit 13. The storage unit 13 is a storage device, such as a hard disk. Various programs including programs concerning the control of the information processing apparatus 100 are stored in the storage unit 13. An operation display unit 14 includes a display area 141, such as a liquid crystal display, functioning as the touch panel. Various images, such as images representing characters and images representing menu lists, are displayed in the display area 141. A user of the information processing apparatus 100 touches the display area 141 with an operator (such as a pen or a finger of the user) to perform various operations. The operation display unit 14 outputs information corresponding to the position of the operator that is in contact with the display area 141. A communication unit 15 is an interface to communicate with another apparatus in a wired manner or wirelessly.

The storage unit 13 includes a moving distance coefficient storage area 131. Coefficients (hereinafter referred to as “moving distance coefficients”) used in an object moving process described below are stored in the moving distance coefficient storage area 131.

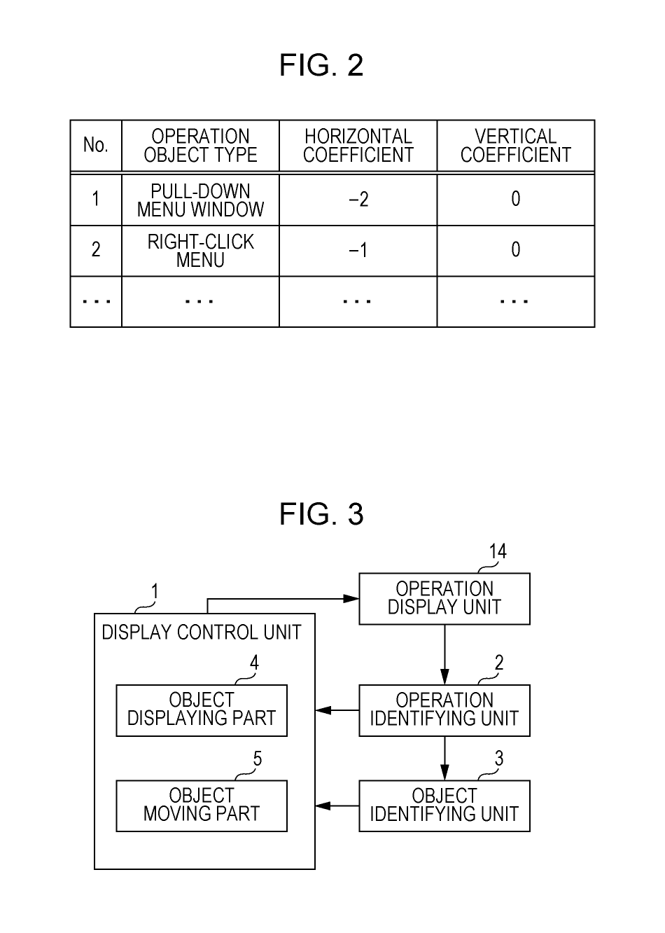

FIG. 2 illustrates an example of the content of storage in the moving distance coefficient storage area 131. Items “operation object type”, “horizontal coefficient”, and “vertical coefficient” are stored in association with each other in a table illustrated in FIG. 2. Among these items, information indicating the type of an image (hereinafter referred to as an “object”), such as a menu, an icon, a window, etc., displayed in the display area 141 of the operation display unit 14 is stored in the item “operation object type.” The moving distance coefficient in the horizontal direction (hereinafter referred to as an “x-axis direction”) with respect to the orientation of the screen is stored in the item “horizontal coefficient.” The moving distance coefficient in the vertical direction (hereinafter referred to as a “y-axis direction”) of the screen with respect to the orientation of the screen is stored in the item “vertical coefficient.”

FIG. 3 is a block diagram illustrating an example of the functional configuration of the information processing apparatus 100. Referring to FIG. 3, a display control unit 1, an operation identifying unit 2, and an object identifying unit 3 are realized by the control unit 12 that reads out the computer programs stored in the ROM 122 or the storage unit 13 to execute the computer programs that are read out. Arrows in FIG. 3 indicate flows of data. The display control unit 1 displays various images in the display area 141 of the operation display unit 14. The display control unit 1 includes an object display part 4. The object display part 4 displays one or more images (objects) in the display area 141 of the operation display unit 14.

The operation identifying unit 2 identifies the operation by the user in accordance with the information output from the operation display unit 14. The object identifying unit 3 identifies the object pointed with the operator and the type of the object in accordance with the information output from the operation display unit 14 and the content of display in the display area 141. The object identifying process is performed, for example, in the following manner. Specifically, the object identifying unit 3 acquires a list of windows displayed with a window management function (for example, X Window System) of an OS, such as Linux (registered trademark), and scans the list of windows with information about a touched position acquired from the touch panel device to identify the window that is touched. The object identifying unit 3 acquires information about the object that is scanned from the name, the window type attribute, etc. of the window.

An object moving part 5 in the display control unit 1 moves the object identified by the object identifying unit 3 on the display area 141 by a distance corresponding to the moving distances of the operator and the moving distance coefficients associated with the object when the operator moves on the display area 141 with being in contact with the display area 141. In the present exemplary embodiment, the object moving part 5 moves the identified object by a distance resulting from multiplication of the moving distances of the operator by the corresponding moving distance coefficients in the x-axis direction and the y-axis direction. The “movement of the object” in the present exemplary embodiment includes a scrolling operation of an object, such as a window, with a scroll bar.

### Operation

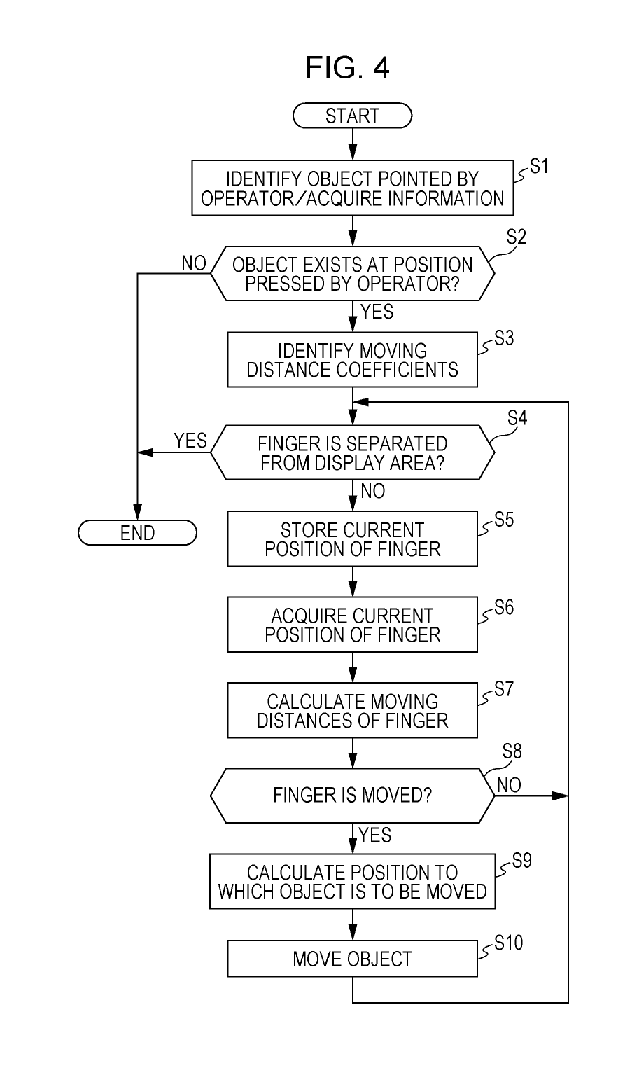

FIG. 4 is a flowchart illustrating a process performed by the information processing apparatus 100. The process illustrated in FIG. 4 is performed in response to a touch of the operator on the display area 141 of the operation display unit 14. Referring to FIG. 4, the control unit 12 performs the processing by the operation identifying unit 2 and the object identifying unit 3 described above. Specifically, in Step S1, the control unit 12 identifies a position on the display area 141 pointed by the operator and identifies an object pointed by the operator in accordance with the information output from the operation display unit 14. In Step S2, the control unit 12 determines whether the object exists at the position pointed by the operator (pressed by the operator). If the control unit 12 determines that the object does not exist at the position pointed by the operator (NO in Step S2), the process in FIG. 4 is terminated. If the control unit 12 determines that the object exists at the position pointed by the operator (YES in Step S2), the process goes to Step S3 and the subsequent steps.

In Step S3, the control unit 12 identifies the moving distance coefficient corresponding to the object pointed by the operator with reference to the table stored in the moving distance coefficient storage area 131. In the present exemplary embodiment, the control unit 12 identifies the type of the object pointed by the operator and identifies the “horizontal coefficient” and the “vertical coefficient” corresponding to the identified type. Specifically, for example, when the type of the object is “pull-down menu window”, the control unit 12 identifies the “horizontal coefficient” as “−2” and identifies the “vertical coefficient” as “0.”

In Step S4, the control unit 12 determines whether the operator (finger) is separated from the display area 141. If the control unit 12 determines that the operator is separated from the display area 141 (YES in Step S4), the process in FIG. 4 is terminated. If the control unit 12 determines that the operator is not separated from the display area 141 (NO in Step S4), in Step S5, the control unit 12 stores the current position of the operator (finger). The control unit 12 repeats the processing from Step S5 to Step S10 until the operator is separated from the display area 141 (NO in Step S4) to update the display of the display area 141. Specifically, in Step S6, the control unit 12 acquires the current position of the operator on the display area 141. In Step S7, the control unit 12 calculates the difference between the position identified in Step S5 and the current position, that is, the moving distance of the position pointed by the operator. In the present exemplary embodiment, the control unit 12 calculates the moving distances of the operator in the horizontal direction and the vertical direction of the screen with respect to the orientation of the screen.

In Step S8, the control unit 12 determines whether the operator is moved on the basis of the result of the calculation in Step S7. In the present exemplary embodiment, it is determined that the operator is not moved if the result of the calculation in Step S7 is equal to zero and it is determined that the operator is moved if the result of the calculation in Step S7 is not equal to zero. If the control unit 12 determines that the operator is not moved (NO in Step S8), the process goes back to Step S4. If the control unit 12 determines that the operator is moved (YES in Step S8), in Step S9, the control unit 12 multiplies the moving distances of the operator calculated in Step S7 by the moving distance coefficients identified in Step S3 in the vertical direction and the horizontal direction of the screen to identify the moving distance of the object in the horizontal direction and the moving distance of the object in the vertical direction. In Step S10, the control unit 12 moves the object by the moving distances calculated in Step S9. Specifically, in the present exemplary embodiment, the control unit 12 calculates positions X_{new} and Y_{new} of the object after the movement according to the following equations:

X_{new}=X_{now}+h×Δx

Y_{new}=Y_{now}+v×Δy

where X_{now} and Y_{now} denote the positions of the object before the movement, Δx and Δy denote the moving distances of the operator (finger), and h and v denote the moving distance coefficients.

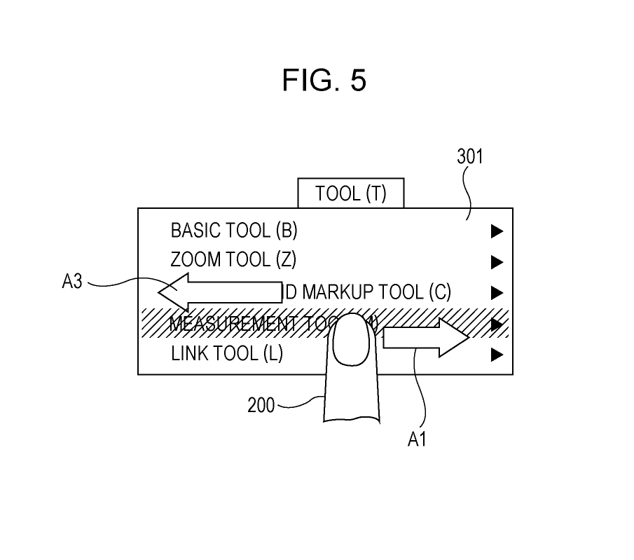

How an object is moved will now be specifically described with reference to FIG. 5 and FIG. 7. FIG. 5 is a diagram for describing an example of the object moving process performed by the control unit 12. In the example illustrated in FIG. 5, a case is indicated in which the pull-down menu window is pointed with a finger 200 of the user (the operator) and the finger of the user is moved in the direction indicated by an arrow A1 with being in contact with the display area 141. In the example illustrated in FIG. 5, the control unit 12 calculates the moving distance of the position pointed by the finger 200 and multiplies the calculated moving distance by the moving distance coefficients corresponding to the type of the pull-down menu window to calculate the amount of movement of the object. Specifically, for example, when the moving distance coefficients have the content illustrated in FIG. 2 (that is, the moving distance coefficient in the x-axis direction is equal to “−2” and the moving distance coefficient in the y-axis direction is equal to “0”), the control unit 12 moves an object 301 in a direction (the direction indicated by an arrow A3 in FIG. 5) opposite to the moving direction of the finger 200 in the x-axis direction by an amount double the amount of movement of the finger 200.

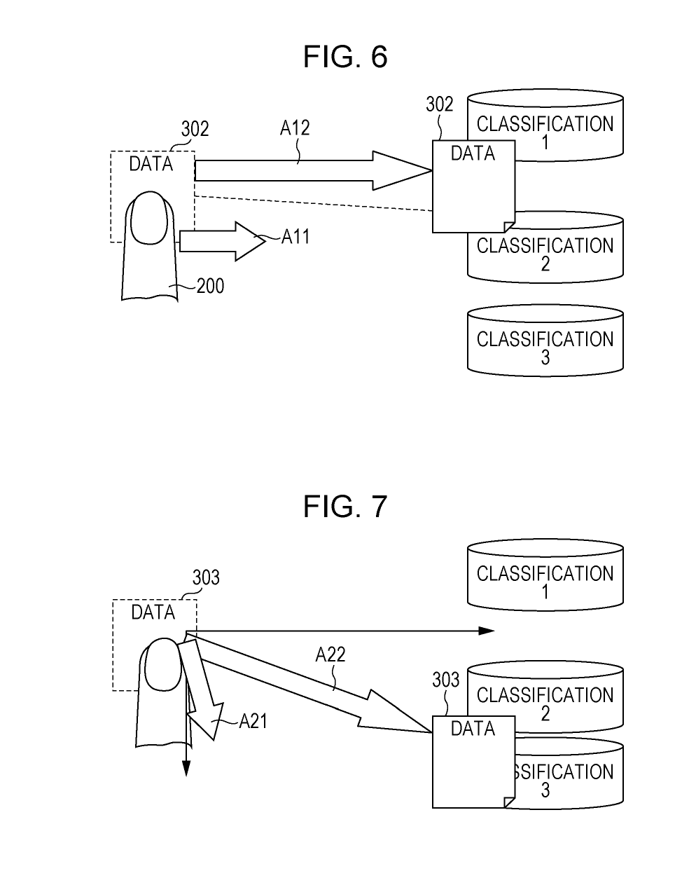

FIG. 6 is a diagram for describing another example of the object moving process performed by the control unit 12. In the example illustrated in FIG. 6, a case is indicated in which an image (hereinafter referred to as an “icon”) 302 representing an object, such as document data or a folder, is pointed by the finger 200 of the user (the operator) and the finger 200 of the user is moved in a direction (the direction indicated by an arrow A11) parallel to the x-axis direction with being in contact with the display area 141. For example, when the moving distance coefficient in the x-axis direction corresponding to the type of the icon 302 is equal to “5”, the control unit 12 moves the icon 302 in a direction (the direction indicated by an arrow A12) in which the operator is moved along the x axis by an amount of movement which is five times of the amount of movement of the finger 200.

In the screen illustrated in FIG. 6, the control unit 12 (the object moving part 5) displays a graphic (the arrow A12 in FIG. 6) representing the content of movement of the object. The image representing the content of movement of the object is not limited to the image representing the arrow and may be another image. It is sufficient for the image representing the content of movement of the object to allow the user to visually recognize the content of movement, such as a movement locus, of the object. Alternatively, if the distance between the position of the operator (finger) and the position where the object is displayed exceeds a predetermined threshold value, the control unit 12 may display an image representing the content of movement of the object.

FIG. 7 is a diagram for describing another example of the object moving process performed by the control unit 12. In the example illustrated in FIG. 7, a case is indicated in which an icon 303 representing an object, such as document data or a folder, is pointed by the finger 200 of the user (the operator) and the finger 200 of the user is moved in the direction indicated by an arrow A21 with being in contact with the display area 141. For example, when the moving distance coefficient in the x-axis direction corresponding to the type of the icon 303 is equal to “6” and the moving distance coefficient in the y-axis direction corresponding to the type of the icon 303 is equal to “1”, the control unit 12 moves the icon 303 by an amount of movement that is six times of the moving distance of the position pointed by the operator in the x-axis direction and that is equal to the moving distance of the position pointed by the operator in the y-axis direction. In the screen illustrated in FIG. 7, the control unit 12 displays a graphic (an arrow A22 in FIG. 7) representing the content of movement of the object. The graphic representing the content of movement of the object is not limited to the image representing the arrow and may be another image.

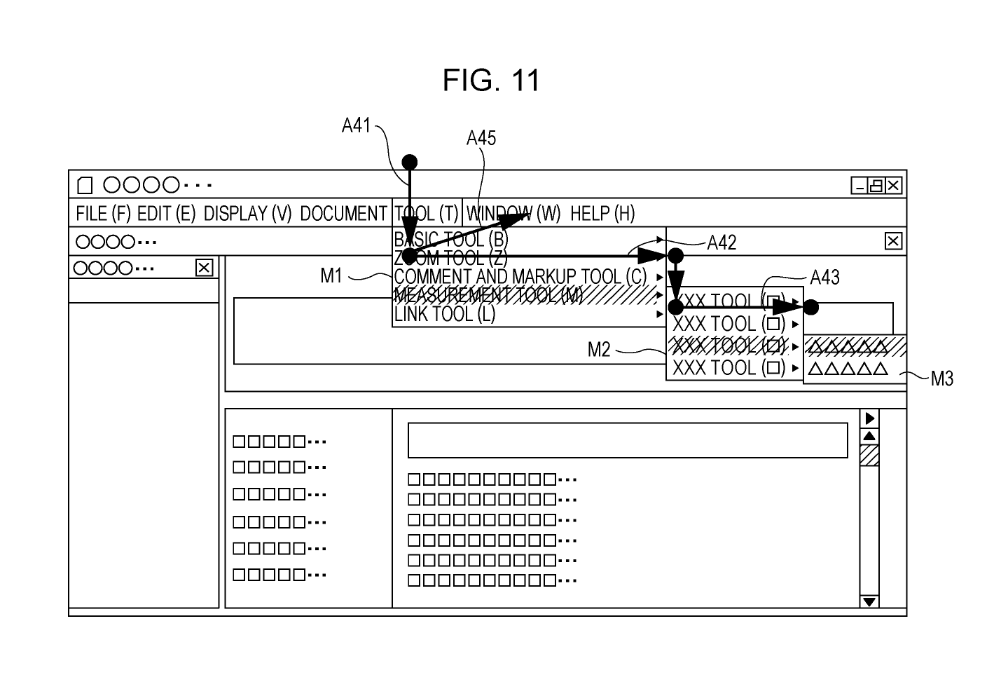

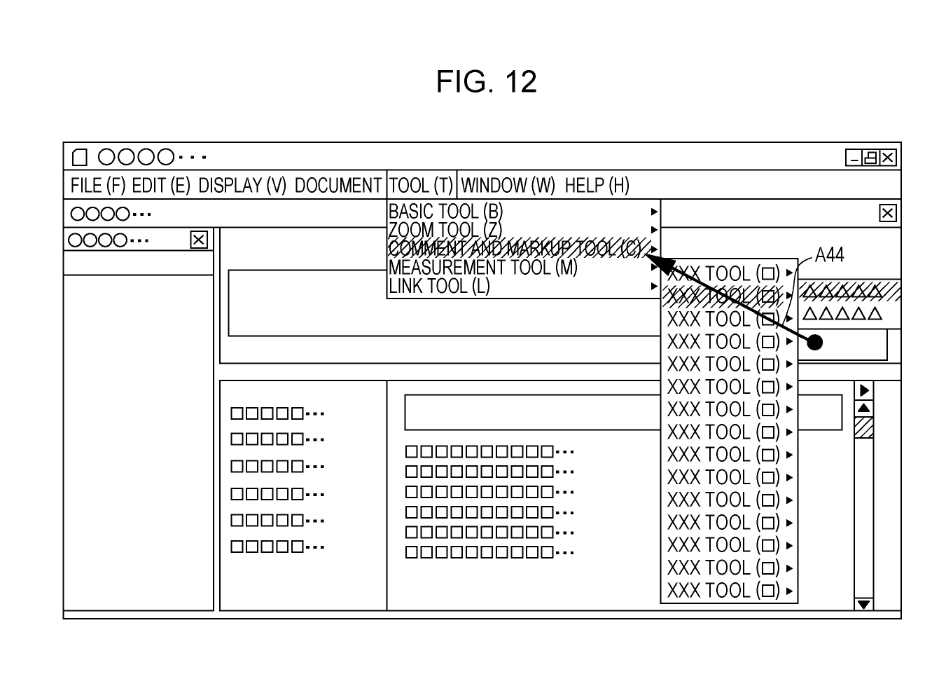

It is necessary to move the finger by a distance longer than that of a mouse in order to perform a touch operation to software in the related art which is based on a mouse operation and uses many menus. Specifically, as illustrated in FIG. 11, when a menu M1 is selected and submenus M2 and M3 are further selected, it is necessary to move the finger along arrows A41, A42, and A43 with being in contact with the display area 141. In this case, there is a case in which it is difficult to move the finger straight in the x-axis direction, as illustrated by the arrow A42. For example, there is a case in which the moving direction of the finger is shifted in a manner illustrated by an arrow A45. In addition, in order to re-select a menu item from the menu, it is necessary to move the finger by a longer distance, as illustrated by an arrow A44 in FIG. 12. As described above, it may be difficult to perform the operation when the finger is moved by a longer distance with being in contact with the display area 141. Specifically, for example, since an operation to slide the forefinger of the right hand leftward or upward is generally caught (has a large friction force), it is difficult to perform the operation (refer to FIG. 12). In contrast, in the present exemplary embodiment, on a user interface (UI) requiring the finger that is in contact with the display area 141 to move straight in a specific direction by a longer distance on the display, setting the moving distance coefficients to appropriate values allows the moving distance to be decreased to facilitate the operation.

### Modifications

While the invention is described in terms of some specific examples and embodiments, it will be clear that this invention is not limited to these specific examples and embodiments and that many changes and modifications will be obvious to those skilled in the art without departing from the spirit and scope of the invention. The following modifications may be combined with each other.

(1) The moving distance coefficients are stored in the moving distance coefficient storage area 131 of the storage unit 13 for every object type and the control unit 12 identifies the type of an object pointed by the operator and identifies the moving distances of the object by using the moving distance coefficients corresponding to the identified type in the above exemplary embodiments. However, the configuration of the information processing apparatus is not limited to the above one and the moving distance coefficients may not be stored for every object type. Specifically, the control unit 12 may calculate the moving distances of the object in accordance with predetermined coefficients, regardless of the type of the object.

(2) Although the moving distance coefficients are set in advance for the two directions: the x-axis direction and the y-axis direction in the above exemplary embodiments, the mode of setting the moving distance coefficients is not limited to the above one. For example, the moving distance coefficients may be set for three directions: the x-axis direction, the y-axis direction, and the z-axis direction. Alternatively, the moving distance coefficient may be set for one direction, instead of multiple directions.

Although the moving distance coefficients are set in advance for the two directions: the x-axis direction and the y-axis direction orthogonal to the x-axis direction in the above exemplary embodiments, the two directions may not be orthogonal to each other. The moving distance coefficients may be set in multiple directions having other relationship.

Although the case in which the value of the “vertical coefficient” is set to zero for the types “pull-down menu window” and “right click menu”, as illustrated in FIG. 2, is described in the above exemplary embodiments, the values of the moving distance coefficients is not limited to zero and the moving distance coefficients may have various values.

(3) Each of the moving distance coefficients may be set for every application running on the information processing apparatus 100 in the above exemplary embodiments. In this case, the control unit 12 may use the moving distance coefficients specified by the user with the operation display unit 14 in an application for which the moving distance coefficients are not set.

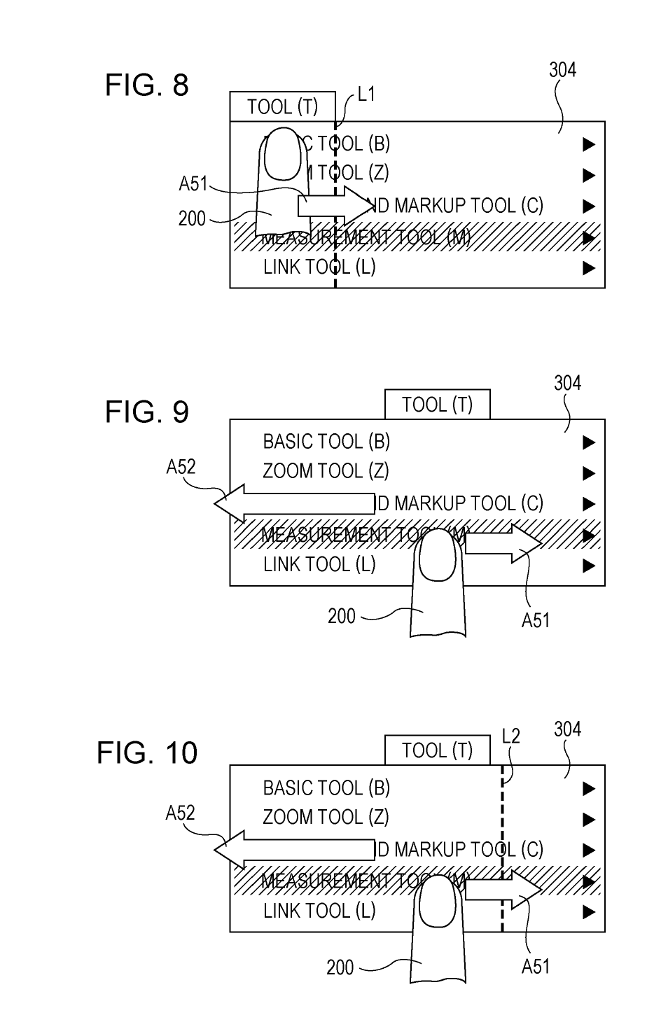

(4) The moving distance coefficients may be varied depending on the position of the operator in the object in the above exemplary embodiments. Specifically, the moving distance coefficients may be set for every area resulting from division of the object. A specific example in this case will now be described with reference to FIG. 8 to FIG. 10. In this modification, areas (hereinafter referred to as “both-ends areas”) at both ends in the x-axis direction of the object having the “pull-down menu window” type, which each have a width that is one fourth of the entire width of the object, and the remaining central area have different moving distance coefficients. Specifically, “2” may be set as the “horizontal coefficient” and “0” may be set as the “vertical coefficient” for the central area and “0” may be set as the “horizontal coefficient” and “0” may be set as the “vertical coefficient” for the both-ends areas. In this case, since both the horizontal coefficient and the vertical coefficient have a value of zero in the both-ends areas, the object is not moved when the operator is positioned in the both-ends areas. When the object is pointed (touched) by the operator, the control unit 12 determines whether the operator is positioned in the both-ends areas or in the central area and calculates the moving distances of the object by using the moving distance coefficients corresponding to the respective areas.

In the example illustrated in FIG. 8 to FIG. 10, when the user moves the finger 200 in a direction (the direction indicated by an arrow A51) parallel to the x-axis direction, an object 304 is not moved until the finger 200 is over a line L1. When the finger 200 is over the line L1, the object 304 starts to move in a direction (the direction indicated by an arrow A52 in FIG. 9) opposite to the moving direction of the finger. Then, when the finger 200 moves in the direction indicated by the arrow A51 and reaches a line L2, the object 304 stops sliding (movement). In this example, since the movement of the object is stopped immediately before a submenu item is selected (when the finger reaches the line L2), it is easy for the user to perform the selection.

(5) The values of the moving distance coefficients may be set by the user in the above exemplary embodiments. In this case, in response to an operation by the user with the operation display unit 14, the operation display unit 14 outputs information corresponding to the content of the operation by the user and the control unit 12 sets the values of the moving distance coefficients in accordance with the information output from the operation display unit 14.

(6) The control unit 12 may dynamically vary the values of the moving distance coefficients in the above exemplary embodiments. Specifically, the control unit 12 may vary the values of the moving distance coefficients in accordance with the amount of movement of the object. For example, the control unit 12 may decrease the absolute values of the moving distance coefficients if the amount of movement of the object exceeds a predetermined threshold value. Decreasing the absolute values of the moving distance coefficients (that is, reducing the movement speed) with the increasing amount of movement of the object allows the user to easily perform, for example, a small moving operation after the object is moved to a rough position. As a mode of varying the moving distance coefficients, for example, a table in which the amount of movement of the object is associated with the values of the moving distance coefficients may be stored in the storage unit 13 in advance and the control unit 12 may refer to the table to identify the values of the moving distance coefficients. Alternatively, the values of the moving distance coefficients may be calculated from the amount of movement of the object by using a predetermined function.

In another mode, the control unit 12 may vary the moving distance coefficients in accordance with the display size of the object. For example, the control unit 12 may increase the absolute values of the moving distance coefficients when the icon is large. Increasing the absolute values of the moving distance coefficients with the increasing display size of the object and decreasing the absolute values of the moving distance coefficient with the decreasing display size of the object allow the user to easily perform a small moving operation for a small object.

In another mode, the control unit 12 may vary the values of the moving distance coefficients in accordance with the size of the display area 141 of the operation display unit 14 or the size of the screen on which the object is displayed. Specifically, for example, the absolute values of the moving distance coefficients may be increased with the increasing physical size of the display area 141 and the absolute values of the moving distance coefficients may be decreased with the decreasing physical size of the display area 141. In another mode, the control unit 12 may vary the values of the moving distance coefficients in accordance with the positional relationship between the object to be moved and another object displayed in the display area 141. Specifically, for example, the control unit 12 may decrease the absolute values of the moving distance coefficients if the distance between the object that is being moved and another object displayed in the display area 141 is lower than or equal to a predetermined threshold value.

(7) The control may be performed so that the movement of the object by using the moving distance coefficients is not performed (that is, the object is moved by an amount corresponding to the amount of movement of the cursor in a manner in the related art) when a mouse or a touch pad (a second operator) is used for the operation in the above exemplary embodiments. Specifically, the control unit 12 may identify the object pointed by the second operator in accordance with information output from the mouse or the touch pad (the second operator) operated by the user to move the identified object by the moving distance of a position pointed by the second operator when the position is moved on the display area 141. That is, when the position pointed by the second operator is moved on the display area 141, the control unit 12 may move the object by a distance corresponding to the moving distance of the position pointed by the second operator without using the moving distance coefficients of the object. In contrast, when the operator is moved with being in contact with the operation display unit 14, the control unit 12 may move the object by a distance corresponding to the moving distance of the position pointed by the operator and the moving distance coefficient, as in the above exemplary embodiments. The control unit 12 switches the use of the moving distance coefficients on the basis of the type of the operator in the above manner to allow both the operator and the second operator to achieve the user-friendliness.

The method of switching the use of the moving distance coefficients on the basis of the type of the operator by the control unit 12 is not limitedly used and the control unit 12 may switch the moving distance coefficients to be used on the basis of the type of the operator. In this case, although the moving distance coefficients are stored for every object type, the moving distance coefficients may be further provided for every operator type. The control unit 12 may calculate the moving distances of the object by using values resulting from multiplication of the moving distance coefficients of each object by the moving distance coefficients of each operator.

(8) Although the control unit 12 multiples the moving distances of the operator by the moving distance coefficients to calculate the moving distances of the object in the above exemplary embodiments, the mode of calculating the moving distances of the object is not limited to this. For example, the control unit 12 may use the result of multiplication of the square values of the moving distances of the operator by the moving distance coefficients as the amount of movement of the object. In another mode, for example, the maximum value in the object moving process may be set in advance and, if the result of multiplication of the moving distances of the operator by the moving distance coefficients exceeds a predetermined threshold value, the threshold value may be used as the moving distances of the object. It is sufficient for the control unit 12 to move the object by a distance corresponding to the moving distances of the operator and the moving distance coefficients of the object.

(9) Although the operator (for example, a finger) is made in contact with the display area 141 of the operation display unit 14 to identify the position pointed on the display area 141 in the above exemplary embodiments, the mode of identifying the position pointed on the display area 141 by the user is not limited to this. It is sufficient for the position pointed on the display area 141 to be identified with a sensor. When the position pointed by the operator is moved on the display area 141 in a state in which the object is pointed by the user (a state in which the object is identified by the object identifying unit 3), the identified object may be moved on the display area 141 by a distance corresponding to the moving distance coefficients. Specifically, for example, a sensor that detects the motion of the eye balls of the user (the operator) may be provided in the information processing apparatus 100. In this case, the control unit 12 may identify the position that is pointed by identifying the direction of the line of sight of the user in accordance with the result of the detection from the sensor. Also in this mode, moving the object pointed by the user by a distance corresponding to the moving distance coefficients reduces the amount of the operation to move the position pointed by the user on the display area 141.

(10) Although the single information processing apparatus 100 is used in the above exemplary embodiments, two or more apparatuses connected via a communication unit may share the function of the information processing apparatus 100 according to the exemplary embodiments and a system including the multiple apparatuses may realize the information processing apparatus 100 according to the exemplary embodiments. For example, a system in which a first computer apparatus is connected to a second computer apparatus via a communication unit may be configured. In this case, the first computer apparatus is provided with a touch panel. The second computer apparatus identifies the position to which the object is to be moved by the object moving process described above and outputs data for updating the content of display on the touch panel to the first computer apparatus.

(11) The programs stored in the ROM 122 or the storage unit 13 described above may be provided in a state in which the programs are stored on a computer-readable recording medium, such a magnetic recording medium (a magnetic tape, a magnetic disk (hard disk drive (HDD)), a flexible disk (FD), etc.), an optical recording medium (an optical disk, etc.), a magneto-optical recording medium, or a semiconductor memory. Alternatively, the programs may be downloaded into the information processing apparatus 100 via a communication line, such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an object displaying unit that displays at least one object in a display area of an operation display, the operation display including the display area where an image is displayed and outputting information about a position pointed by an operator in the display area;
an object identifying unit that identifies an object pointed by the operator in accordance with the information output from the operation display; and
an object moving unit that, when the position pointed by the operator is moved on the display area in a state in which the object is identified by the object identifying unit, moves the object identified by the object identifying unit on the display area by a distance corresponding to a moving distance of the position pointed by the operator and a coefficient that is associated with the object and that is set in advance in at least one direction.

2. The information processing apparatus according to claim 1,
wherein the operation display outputs information about a position pointed by the operator that is in contact with the display area, and
wherein, when the operator is moved on the display area with being in contact with the display area, the object moving unit moves the object identified by the object identifying unit on the display area by a distance corresponding to a moving distance of the position pointed by the operator and a coefficient that is associated with the object and that is set in advance in at least one direction.

3. The information processing apparatus according to claim 1, further comprising:
a coefficient memory that stores a coefficient concerning a moving distance of the object in at least one direction that is set in advance for every object type,
wherein the object identifying unit identifies an object pointed by the operator and the type of the object in accordance with the information output from the operation display, and
wherein, when the position pointed by the operator is moved on the display area in the state in which the object is identified by the object identifying unit, the object moving unit moves the object identified by the object identifying unit on the display area by a distance corresponding to a moving distance of the position pointed by the operator and a coefficient associated with the identified type of the object.

4. The information processing apparatus according to claim 2, further comprising:
a coefficient memory that stores a coefficient concerning a moving distance of the object in at least one direction that is set in advance for every object type,
wherein the object identifying unit identifies an object pointed by the operator and the type of the object in accordance with the information output from the operation display, and
wherein, when the position pointed by the operator is moved on the display area in the state in which the object is identified by the object identifying unit, the object moving unit moves the object identified by the object identifying unit on the display area by a distance corresponding to a moving distance of the position pointed by the operator and a coefficient associated with the identified type of the object.

5. The information processing apparatus according to claim 1,
wherein the coefficient is set for every area resulting from division of the object.

6. The information processing apparatus according to claim 1, further comprising:
a coefficient setting unit that sets a value of the coefficient in accordance with information output from the operation display on the basis of the content of an operation by a user.

7. The information processing apparatus according to claim 1,
wherein the object identifying unit identifies an object pointed by the operator and a second operator operated by the operation display and a user in accordance with information output from the second operator, and
wherein, when a position pointed by the second operator operated by the user is moved on the display area, the object moving unit moves the object identified by the object identifying unit on the display area by a distance corresponding to a moving distance of the position.

8. An information processing method comprising:
displaying at least one object in a display area of an operation display, the operation display including the display area where an image is displayed and outputting information about a position pointed by an operator in the display area;
identifying an object pointed by the operator in accordance with the information output from the operation display; and
moving, when the position pointed by the operator is moved on the display area in a state in which the object is identified, the identified object on the display area by a distance corresponding to a moving distance of the position pointed by the operator and a coefficient that is associated with the object and that is set in advance in at least one direction.

9. A non-transitory computer readable medium storing a program causing a computer to execute a process comprising:
displaying at least one object in a display area of an operation display, the operation display including the display area where an image is displayed and outputting information about a position pointed by an operator in the display area;
identifying an object pointed by the operator in accordance with the information output from the operation display; and
moving, when the position pointed by the operator is moved on the display area in a state in which the object is identified, the identified object on the display area by a distance corresponding to a moving distance of the position pointed by the operator and a coefficient that is associated with the object and that is set in advance in at least one direction.
